(19) United States
(12) Patent Application Publication
(10) Pub. No.: US 2013/0328948 A1
(43) Pub. Date: Dec. 12, 2013

(54) Combined Emissive and Reflective Dual Modulation Display System

(71) Applicant: Dolby Laboratories Licensing Corporation, San Francisco, CA (US)

(72) Inventors: Timo Kunkel, Campbell, CA (US); Scott Daly, Kalama, WA (US)

(21) Appl. No.: 13/909,939

(22) Filed: Jun. 4, 2013

Related U.S. Application Data
(60) Provisional application No. 61/656,158, filed on Jun. 6, 2012.

(51) Int. Cl. G09G 3/22

(52) U.S. Cl. CPC G09G 3/22
USPC 345/690; 345/87

(57) ABSTRACT

Pixels of a display system may comprise light emitting elements whose light output levels are set based on image data as well as background areas whose light reflectance levels are set based on the same image data. These light output levels and/or light reflectance levels may also be adjusted based on an ambient light level. The background areas may comprise light reflective elements which may be controlled individually or as a whole. The light output levels of the light emitting elements and the light reflectance levels of the light reflective elements are configured to generate collectively a pixel value for the pixel dependent on the image data. One or more modulation algorithms may be used to control the energy consumption, dynamic range, color gamut, point-spread function, etc., of the pixels in the display system.

### CROSS REFERENCE TO RELATED APPLICATIONS

This application claims the benefit of U.S. Provisional Application No. 61/656,158 filed on Jun. 6, 2012, which is hereby incorporated by reference in its entirety.

### TECHNOLOGY

The present invention relates generally to display systems, and in particular, to display systems that comprise two or more levels of light modulations.

### BACKGROUND

In existing light emitting display (LED) wall systems, the background surrounding the individual LEDs is typically painted black to reduce ambient light scattering as well as light bleeding from LEDs—which are set to bright states based on specific images to be rendered—into the area of surrounding LEDs—which may or may not be set to bright states based on the specific images to be rendered. Painting the background black allows for deeper black levels. However, overall luminance yield of the LEDs is reduced, as only directly emitted light from the LEDs can reach viewers and other light such as scattered light is wasted because of light absorption by the black background.

Additionally, for images with large bright regions, the black background surrounding the LEDs or active pixels create a visual artifact of a black grid pattern in the large bright regions, similar to visual artifacts caused by shadow masks in other displays such as CRTs and LCDs. The visual artifact of the black grid pattern may be ameliorated by spatially compressing the LEDs to reduce spatial gaps in between the LEDs. However, the visibility of details on such display systems deteriorates accordingly, as the pixels represented by the LEDs may be too close for human vision to properly resolve embedded image details. Also, increasing the resolution of pixels by compressing or reducing spatial gaps among the pixels greatly increases the system cost.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### BRIEF DESCRIPTION OF DRAWINGS

The present invention is illustrated by way of example, and not by way of limitation, in the figures of the accompanying drawings and in which like reference numerals refer to similar elements and in which:

FIG. 1A through FIG. 1C illustrate an example display panel of a combined emissive and reflective dual modulation display system, in accordance with an embodiment;

FIG. 2A through FIG. 2C illustrate an example pixel (104-3) of a display panel (e.g., 102 of FIG. 1A) in different display states, in accordance with an embodiment;

FIG. 3A and FIG. 3B illustrate an example combined emissive and reflective dual modulation display system, in accordance with an embodiment;

FIG. 4A and FIG. 4B illustrate flow charts representing some operations performed in a combined emissive and reflective dual modulation display system, in accordance with an embodiment;

FIG. 5 illustrates an example tiling configuration;

FIG. 6A and FIG. 6B illustrate example process flows; and

FIG. 7 illustrates an example hardware platform on which a computer or a computing device as described herein may be implemented, in accordance with an embodiment.

### DESCRIPTION OF EXAMPLE EMBODIMENTS

Example embodiments, which relate to combined emissive and reflective dual modulation display system, are described herein. In the following description, for the purposes of explanation, numerous specific details are set forth in order to provide a thorough understanding of the present invention. It will be apparent, however, that the present invention may be practiced without these specific details. In other instances, well-known structures and devices are not described in exhaustive detail, in order to avoid unnecessarily including, obscuring, or obfuscating the present invention.

Example embodiments are described herein according to the following outline:
1. GENERAL OVERVIEW
2. EXAMPLE DISPLAY PANELS
3. LIGHT EMITTING ELEMENTS, LIGHT REFLECTIVE ELEMENTS, OR PIXELS
4. EMISSIVE AND REFLECTIVE LIGHT MODULATION
5. EXAMPLE DISPLAY SYSTEM
6. EMISSIVE MODULES AND REFLECTIVE TILES
7. PASSIVE REFLECTOR
8. EXTERNAL LIGHT SOURCES AND/OR ADDITIONAL MODULATION LAYERS
9. MODULATION ALGORITHMS
10. EXAMPLE PROCESS FLOW
11. IMPLEMENTATION MECHANISMS—HARDWARE OVERVIEW
12. EQUIVALENTS, EXTENSIONS, ALTERNATIVES AND MISCELLANEOUS

### 1. General Overview

This overview presents a basic description of some aspects of an embodiment of the present invention. It should be noted that this overview is not an extensive or exhaustive summary of aspects of the embodiment. Moreover, it should be noted that this overview is not intended to be understood as identifying any particularly significant aspects or elements of the embodiment, nor as delineating any scope of the embodiment in particular, nor the invention in general. This overview merely presents some concepts that relate to the example embodiment in a condensed and simplified format, and should be understood as merely a conceptual prelude to a more detailed description of example embodiments that follows below.

In contrast to other approaches under which display panels such as those of wall display systems use dark or black light absorbing materials as background areas surrounding active light emitters, a display panel under techniques as described herein uses background areas whose reflectance levels vary with the intensity of incident light from light emitting elements surrounded by the background areas. Light output levels of light emitting elements and/or light reflectance levels of light reflective elements in such a display panel may be modulated based on image data. These light output levels and/or light reflectance levels may also be adjusted based on an ambient light level.

As used herein, “a pixel of a display panel” or “a pixel on the display panel” refers to a display unit, of a display panel, whose display states may be separately controllable for the purpose of rendering an image, or a portion thereof, decoded or derived from image data. A pixel of an image refers to a picture element of the image that may be rendered on any of a variety of display panels or tangible media. A pixel of a display panel may have, but is not limited to, a one-to-one correspondence relationship with a pixel of the image. A pixel of a display panel may comprise one or more light emitting elements only in some implementations, or one or more light emitting elements plus their reflective background (e.g., e-paper based reflective background) in some other implementations. In some embodiments, while a spatial dimension assigned to a pixel of a display panel may be fixed, the perceived spatial sizes of the pixel may vary by configuring different reflectance levels and sizes of reflective areas in the reflective background of the pixel. For example, a pixel may comprise a light emitting element and multiple light reflective elements surrounding the light emitting element. Light emitted from the pixel comprises light from the light emitting element as well as light from the light reflective elements. Each of the light emitting element and the light reflective elements may induce a human visual system (HVS) point-spread function. These HVS point-spread function may generate a collective HVS point-spread function that enables a viewer at a distance from a display panel to perceive a larger or smaller pixel size depending on the extent of the reflected and emitted light from the pixel. For the purpose of explanation, “a spatial size of a pixel on a display panel” refers to a perceived spatial size of the pixel. For example, the (perceived) spatial sizes of pixels in the display panel may be adjusted based on image content represented in image data. The (perceived) spatial size of a pixel may be maximized if the pixel is in an image portion with neighboring pixels having similar higher intensity luminance or color values; as a result, the black grid pattern artifact easily visible in other approaches may be removed or significantly reduced. On the other hand, the perceived spatial size of a pixel may be minimized if the pixel is in an image portion with neighboring pixels having lower intensity luminance or color values.

Point-spread functions of pixels may be adjusted based on image content represented in image data. The point-spread function of a pixel may comprise a uniform distribution or a gradient distribution of luminance value and/or color values, depending on what pixel values such as luminance values and/or color values neighboring pixels adjacent to the pixel have. For example, one or more light output levels of one or more light emitting elements in a pixel may be individually or collectively set to generate a variety of different point-spread functions for the pixel. Additionally, optionally, or alternatively, one or more light reflectance levels of one or more light emitting elements in the pixel may also be individually or collective set to generate a variety of different point-spread functions for the pixel.

Light reflectance levels (albedo) of light reflective elements may be overdriven to minimize light output levels of light emitting elements. As used herein, the term “overdrive” refers to increasing the ratio of the reflective light portion (e.g., scattered light waves) or decreasing the ratio of the emissive light portion (e.g., source light waves) in the total output of light from a pixel. The light reflectance levels of the light reflective elements and the light output levels of light emitting elements may be determined jointly, or as functions of the others, based on image content represented in image data. These light output levels and/or light reflectance levels may also be adjusted based on an ambient light level.

Light reflective values of light reflective elements and/or light output levels of light emitting elements may be modulated differently for different light wavelength ranges to support a wide color gamut. A light wavelength range as described herein may refer to a visible light wavelength range in some implementations, or may refer to an invisible or partially invisible light wavelength range (e.g., ultraviolet or infrared light wavelengths). Light reflective values of light reflective elements and light output levels of light emitting elements may be maximized or minimized to support a high dynamic range.

Tiles may be used to cluster a subset of light reflective elements and/or light emitting elements into a segment of a display panel. Tiles may be interleaved to form the display panel. An individual tile may be replaced in the field for upgrade or repair. Image processing logic may comprise remote processing logic that is located away from a display panel, on-board processing logic that is collocated with a display panel, segment-based processing logic that is collocated or integrated with a segment, a combination of the foregoing, etc. Reflective background areas of a display panel or tiles therein may be provided with one or more of quantum dots, e-paper, e-ink, reflective LCD, photochromic materials, etc. External light sources may be used to irradiate a pixel's reflective areas in addition to or in place of one or more light emitting elements for the pixel.

In some embodiments, mechanisms as described herein form a part of an image processing system, including but not limited to: a wall display system, a cinema display system, a theater display system, an advertisement display system, a park display system, a server, studio system, art director system, image editor, color grading or mastering tool, professional reference monitor, animation system, movie studio system, theater systems, cameras, TVs, broadcast system, media recording device, media playing device, video projector, screen (e.g., matte screen, gray screen, silver lenticular screen or the like), laptop computer, netbook computer, tablet computer, cellular radiotelephone, electronic book reader, point of sale terminal, desktop computer, computer workstation, computer kiosk, or various other kinds of terminals and display units.

Various modifications to the preferred embodiments and the generic principles and features described herein will be readily apparent to those skilled in the art. Thus, the disclosure is not intended to be limited to the embodiments shown, but is to be accorded the widest scope consistent with the principles and features described herein.

### 2. Example Display Panels

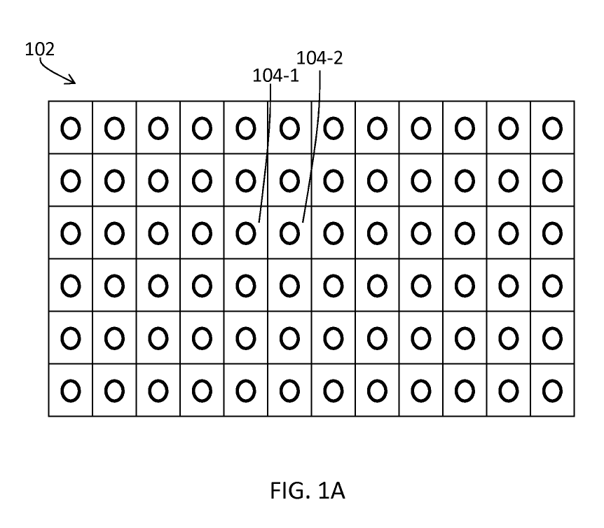

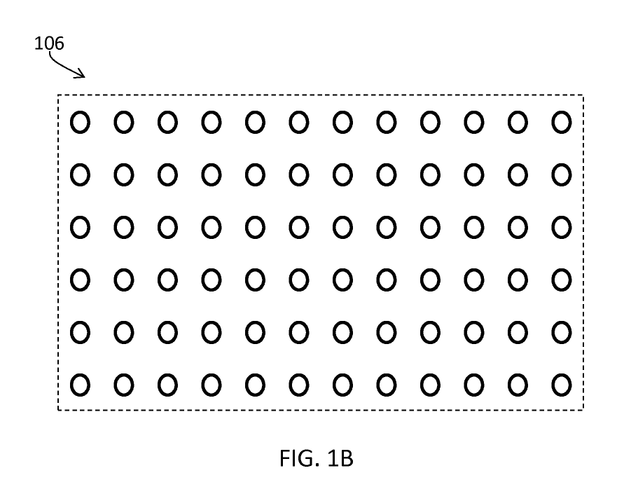

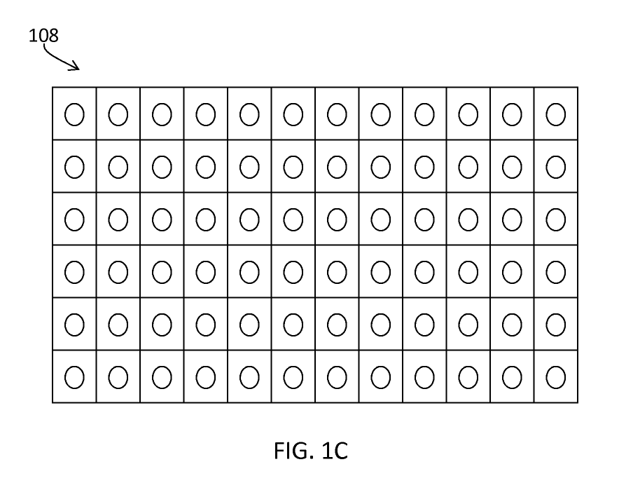

FIG. 1A through FIG. 1C illustrate an example display panel (102) of a combined emissive and reflective dual modulation display system, in accordance with an embodiment. The display panel (102) may comprise a rendering surface of any geometric shape including but not limited to: any of rectangular shapes, polygonal shapes, curved shapes, spherical shapes, concave shapes, convex shapes, irregular shapes, disjoint shapes, etc. For the purpose of illustration only, the display panel (102) may be of a rectangular shape comprising a plurality of pixels (e.g., 104-1, 104-2, etc.). The plurality of pixels may be arranged in a grid pattern as illustrated, or in any other pattern (e.g., diagonal, circular, irregular, etc.). Individual pixels may be of the same shape and/or size, similar shapes and/or sizes, or dissimilar shapes and/or sizes. These pixels may be individually and/or collectively controlled based on image data and/or an ambient light level to render a variety of color or grayscale images.

The rendering surface of the display panel (102) may comprise an active light emitting area (106) as illustrated in FIG. 1B and a passive light reflective area (108) as illustrated in FIG. 1C, which may be interleaved. The active light emitting area (106) comprises individual light emitting areas (e.g., interior areas), of light emitting elements in individual pixels. The passive light reflective area (108) may comprise individual light reflective areas from individual light reflective elements in the individual pixels and may occupy some or all of the remaining area on the rendering surface other than the active light emitting area (106). In an example embodiment, a pixel may be of a center-surround configuration in which a light emitting element is at the center and surrounded by one or more light reflective elements.

The individual light emitting elements in the pixels may be set to specific color values or grayscale values in accordance with image data that comprises one or more images to be rendered on the display panel (102) by the combined emissive and reflective dual modulation display system. Similarly, the individual light reflective light emitting elements in the pixels may be set to specific reflectance levels in accordance with the same image data. These light output levels and/or light reflectance levels may also be adjusted based on ambient light level.

### 3. Light Emitting Elements, Light Reflective Elements, or Pixels

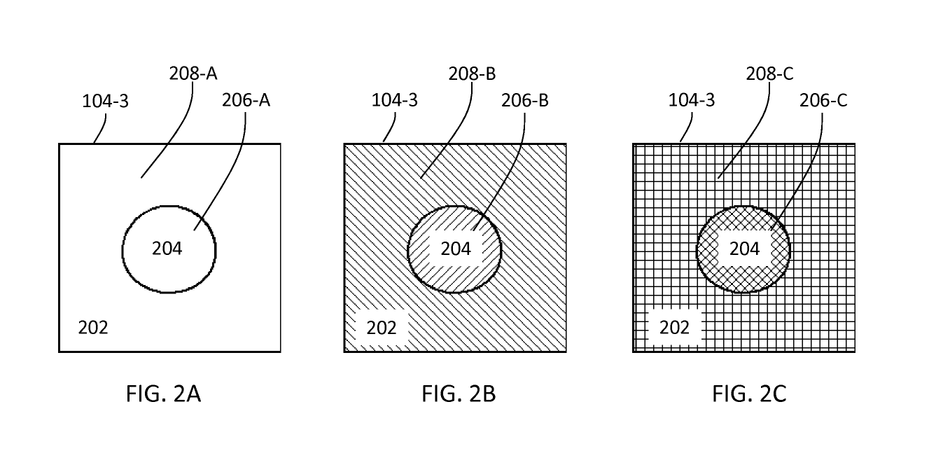

FIG. 2A through FIG. 2C illustrate an example pixel (104-3) of a display panel (e.g., 102 of FIG. 1A) in different display states, in accordance with an embodiment. The pixel (104-3) comprises a light emitting element 204 and a light reflective element 202. The light emitting element (204) may be set to a specific output level in a plurality of light output levels directly or indirectly based, at least in part, on (e.g., a pixel value in) image data. Similarly, the light reflective element 206 may be set to a specific reflectance level in a plurality of light reflectance levels directly or indirectly based, at least in part, on (the pixel value in) the image data. The light output levels and/or light reflectance level may also be adjusted based on ambient light level.

In a first example, to render a first image portion, the pixel (104-3) may be set to a first pixel value of a high luminance value. As illustrated in FIG. 2A, the light emitting element 204 may be set to a first output level, for example, a high light output level represented by an unfilled pattern (206-A), based on the first pixel value. The light reflective element 202 may be set to a first reflectance level, for example, a high reflectance level represented by another unfilled pattern (208-A), based on the first pixel value.

In a second example, to render a second image portion, the pixel (104-3) may be set to a second pixel value of a medium luminance value. As illustrated in FIG. 2B, the light emitting element 204 may be set to a second output level, for example, a medium light output level represented by a first pattern (206-B), based on the second pixel value. The light reflective element 202 may be set to a second reflectance level, for example, a medium reflectance level represented by a second pattern (208-B), based on the second pixel value.

In a third example, to render a third image portion, the pixel (104-3) may be set to a third pixel value of a low luminance value. As illustrated in FIG. 2C, the light emitting element 204 may be set to a third output level, for example, a low light output level represented by a third pattern (206-C), based on the third pixel value. The light reflective element 202 may be set to a third reflectance level, for example, a low reflectance level represented by a third pattern (208-C), based on the third pixel value.

Alternatively, for additional pixel control, the light emitting element 204 can be set to a high light output level while light reflective element 202 is set to a low reflectance level, or light emitting element 204 can be set to a low light output level while light reflective element 202 is set to a high reflectance level.

Examples of light emitting elements include, without limitation: light-emitting diodes (LEDs), cold cathode fluorescent lights (CCFLs), quantum dots, organic light-emitting diodes (OLEDs), fluorescent light sources (e.g., compact fluorescent lights), incandescent light sources, gas discharge lights, etc. A display panel may comprise any number up to a very large number of light emitting elements, for example, two million or more light emitting elements. In some embodiments, each pixel may comprise a light emitting element having one or more monochrome (e.g., grayscale, gradations of a specific color, etc.) component light emitting elements in a single housing or separate housings. In some embodiments, each pixel may comprise a light emitting element having all color (e.g., RGB and/or other primary colors) component light emitting elements in a single housing or separate housings. In some embodiments, each pixel may comprise more than one light emitting element.

Examples of light reflective elements include, without limitation: e-paper, e-ink, reflective liquid crystal display, etc. In an example, reflectance levels/albedos may be variably set based on amounts and types of pigments driven to a particular surface under the influence of an electric field, magnetic field, or electromagnetic field. In another example, LCD with a highly reflective background or layer in which liquid crystal states may be controlled to provide different reflectance levels/albedos.

### 4. Emissive and Reflective Light Modulation

In a combined emissive and reflective dual modulation display system as described herein, reflectivity of the background area other than the light emitting areas may be adjusted based at least in part on image content. When the intensity or light output level of a local light emitting area (e.g., comprising one or more adjacent light emitting elements) is low (e.g. to express black or dark colors), the light reflective elements constituting the background area collocated with the local light emitting area are switched to dark states to reduce reflectivity/albedo for both light from light emitting elements and/or from concurrent ambient illumination. On the other hand, when the intensity or light output level of the local light emitting area is high (e.g. to express white or bright colors), the light reflective elements constituting the background area collocated with the local light emitting area are switched to highly reflective states to increase reflectivity/albedo for both light from light emitting elements and/or from concurrent ambient illumination.

Thus, in the combined emissive and reflective dual modulation display system, both the light emitting elements and the light reflective elements are modulated based on received image data and/or an ambient light level. By adjusting the reflectivity of the background surrounding the light emitting elements, the perceived area of each pixel may change its size and thus appear brighter or dark while maintaining or lowering energy consumption of the light source.

Under the dual modulation approach, point-spread functions of light emitting elements are compensated and/or modified by light reflective elements surrounding the light emitting elements, thereby lowering the visibility of a pixel grid that otherwise might be readily perceived around the light emitting elements (as in other wall display systems that do not implement the techniques as described herein).

Additionally, optionally or alternatively, dual modulation of both the light emitting elements and the light reflective elements increases both the physical luminance levels as well as the perceived lightness, thereby improving light output efficiency. Because of the lowering of the pixel grid visibility and/or the increasing of perceived lightness, the combined emissive and reflective dual modulation display system is able to support high quality image viewing at close ranges as well as at relatively distant ranges (e.g., in a stadium environment, in a park environment, in a concert environment, etc.).

In some embodiments, a light emitting element comprises a monochrome light emitter with its particular spectral power distribution (e.g. panchromatic, monochromatic, etc.). In some embodiments, a light emitting element comprises component light emitters of two, three, or more different colors (with their respective spectral power distribution). For example, a single light emitting element may comprise red, green, and blue LEDs. Some or all of the component light emitters in the light emitting element may be individually controllable, for example, based on (e.g., component pixel values in, etc.) image data and/or an ambient light level.

In some embodiments, light reflective elements may comprise monochrome light reflectors with its particular spectral power distribution (e.g. panchromatic, monochromatic, etc.). In an example, the light reflective elements that form the background area of light emitting elements in a display panel may be reflective across a broad spectrum of visible light wavelengths. In another example, the light reflective elements may be reflective with selected spectral regions of a broad spectrum of visible light wavelengths, for example, the selected spectral regions may be configured to match the power spectrum (e.g., certain red, green, or blue wavelengths or wavelength ranges of emitted light, etc.) of the light emitting elements at full light output levels of all color component light emitters in the light emitting elements. In yet another example, the light reflective elements may be reflective with selected spectral regions that do not necessarily match the power spectrum of the light emitting elements. Individual color reflectance levels in a light reflective element may be separately controllable, for example, based on component pixel values of one or more pixels in image data and/or an ambient light level. In some embodiments, the light reflective elements, while reflective with light from the light emitting elements, may be absorptive or non-reflective with respect to other types of incident/scatter light including but not limited to at least a portion of ambient light. In some embodiments, the light reflective elements may be configured to be reflective in one or more specific colors (e.g., red), but not reflective or weakly reflective (relative to the one or more specific colors) in other colors (e.g., blue).

In some embodiments, the light emitting elements and the light reflective elements may be differentially driven. For example, a relative reflectance level (e.g., actual reflectance level divided by maximum reflectance level) of a light reflective element in a pixel may be linearly or nonlinearly related to a relative light output value (e.g., actual light output value divided by maximum light output value) of a corresponding light emitting element in the pixel. In a particular embodiment, a light reflective element may be overdriven in relation to a corresponding light emitting element.

Additionally, optionally, or alternatively, depending on the properties of the reflector material used to implement the light reflective elements, the light reflective elements may be coated with UV converting materials (e.g., ‘whiteners’) to further increase the total luminance output by converting the UV component of emitted light from the light emitting elements or ambient light into visible light (fluorescence). Additionally, optionally, or alternatively, the dark part of the reflector material may be coated with materials showing extremely low albedo values, for example, with carbon nano-tubes forming a light-trap.

### 5. Example Display System

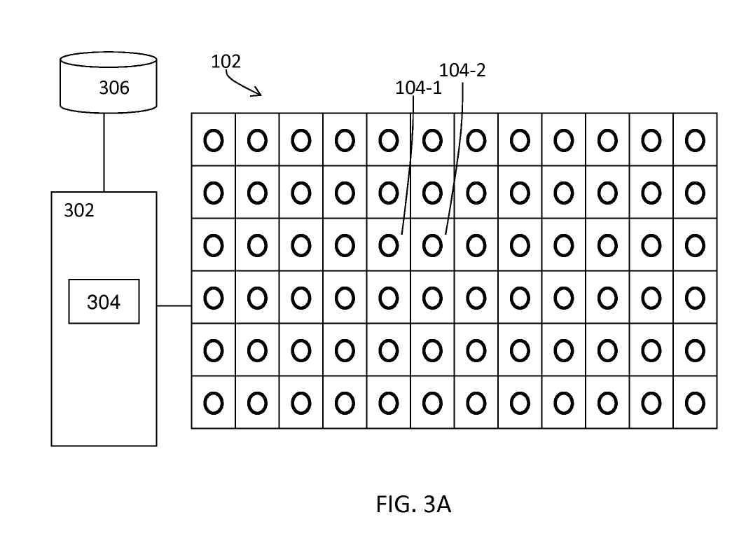

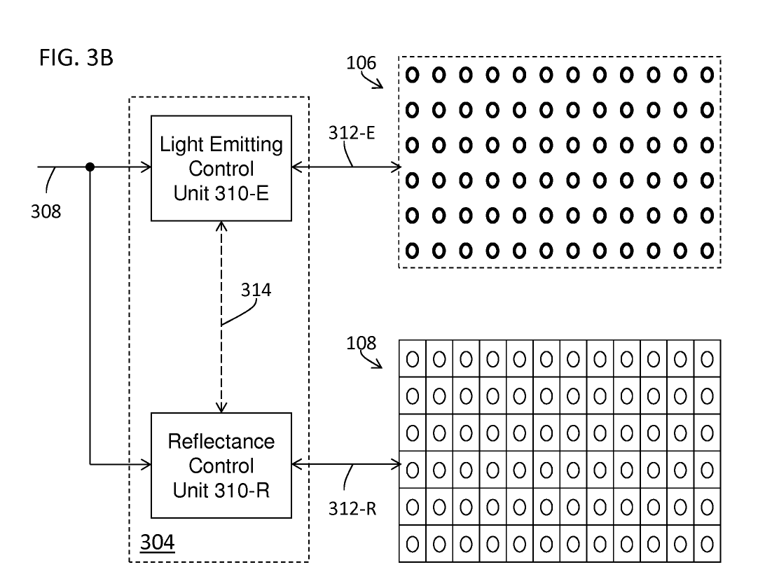

FIG. 3A illustrates an example combined emissive and reflective dual modulation display system, according to an embodiment. Display controller 302 may be configured to control the light emitting elements and the light reflective elements in a display panel (102). The display controller 302 may be operatively coupled to the display panel (102). The display controller 302 is operatively coupled with an image data source 306 and is configured to receive image data from the image data source 306. The image data may be provided by the image data source 306 in a variety of ways including from over-the-air broadcast, a set-top box, a networked server coupled to the display system, and/or a storage medium. The display controller 302 may comprise combined emissive and reflective control module 304 that implements one or more light modulation algorithms to set light output levels and light reflectance levels of individual pixels, a group of pixels, or all the pixels in the display panel (102) based on the image data and/or an ambient light level.

In some embodiments, a single processing unit, in the combined emissive and reflective control module (304), may be used to control both the light emitting elements (e.g., 106 of FIG. 1B) and the light reflective elements (e.g., 108 of FIG. 1C).

In some other embodiments, as illustrated in FIG. 3B, separate processing units may, in the combined emissive and reflective control module (304), may be used to control both the light emitting elements (e.g., 106 of FIG. 1B) and the light reflective elements (e.g., 108 of FIG. 1C). In FIG. 3B, image data (308) received from the image data source (306) may be decoded and sent to a light emitting control unit (310-E) that is configured to control the light emitting elements (106) based at least in part on the image data (308) and a reflectance control unit (310-R) that is configured to control the light reflective elements (108) based at least in part on the image data (308). The light emitting control unit (310-E) may be configured to generate emissive control signals (312-E) to set the light output levels of individual pixels, a group of pixels, or all the pixels in the light emitting elements (106) based on the image data. The reflectance control unit (310-R) may be configured to generate reflectance control signals (312-R) to set the light reflectance levels of individual pixels, a group of pixels, or all the pixels in the light reflective elements (108) based on the image data. The light emitting control unit (310-E) and the reflectance control unit (310-R) may be operatively linked through an optional two-way communication or control link (314). The link (314) between the light emitting control unit (310-E) and the reflectance control unit (310-R) may be used to coordinate control for the desired pixel size and brightness. The light output levels and/or light reflectance levels may also be adjusted based on an ambient light level.

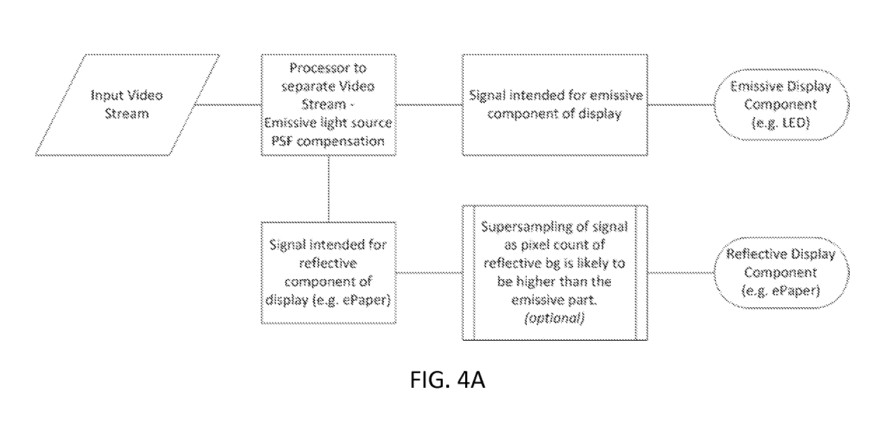

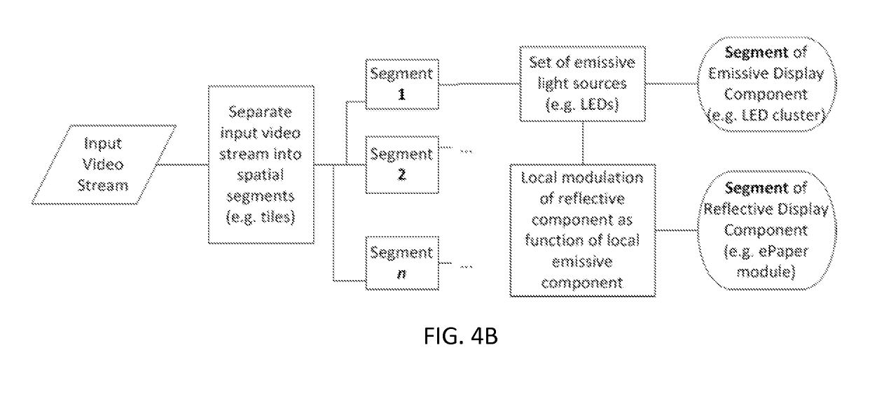

FIG. 4A illustrates a flow chart representing some operations performed in a combined emissive and reflective dual modulation display system, in accordance with an embodiment. The combined emissive and reflective control module 304 of FIG. 3A and FIG. 3B may be configured to perform the operations depicted in FIG. 4A. The control module 304 may be configured to receive an input video stream from an image data source such as 306 of FIG. 3A. The control module 304 may comprise a video decoding processor configured to decode and separate video stream into image frames. An image frame may comprise decoded pixel values in color channels (red, green, blue, luminance, Cb, Cr, etc.) of a color space (e.g., RGB, XYZ, YCbCr, YUV, etc.).

The control module 304 may be configured to determine a distribution of luminance values and color values of the display panel (102) based on pixel values in an image frame. Individual pixels (e.g., 104-1, 104-2, etc., of FIG. 1A) in the display panel may be determined as expressing particular grayscale values or particular color values with particular luminance values. The control module 304 may be configured to determine emissive light source PSF compensation for a pixel based on what the pixel is to express and what the pixel's neighboring pixels are to express. For example, if the neighboring pixels are to express different grayscale values or different color values, then the control module 304 may determine that the pixel's PSF compensation should be relatively low, as the problem of a detectable black grid pattern may not be otherwise serious for the pixel and the neighboring pixels. However, if the neighboring pixels are to express similar grayscale values or similar color values, then the control module 304 may determine that the pixel's PSF compensation should be relatively high, as the problem of a detectable black grid pattern may otherwise be serious for the pixel and the neighboring pixels.

The control module 304 may be configured to control one or more light emitting elements and one or more light reflective elements in a pixel and the pixel's neighboring pixels to generate emissive light source PSF compensation determined based on pixel values or image content of the received image data. For example, a control module 304 may be configured to control reflectance levels of a pixel's light reflective element(s) to achieve the PSF compensation. Additionally, optionally, or alternatively, a control module 304 may be configured to control a light emitting element's light output level or emissive area to achieve the PSF compensation.

After determining emissive light source PSF compensation for pixels in the display panel (102), the control module 304 may be configured to generate (e.g., per-pixel) emissive control signals intended for emissive component(s) of the display panel (102) and to generate (e.g., per-pixel) reflective control signals intended for reflective component(s) of the display panel (102).

In some embodiments, the light reflective elements (108) in the display panel (102) correspond 1-1 to the light emissive elements in the display panel (102). In some other embodiments, the light reflective elements (108) do not correspond 1-1 to the light emissive elements. In an example, a light emissive element may correspond to multiple light reflective elements, each of which may be individually controlled in terms of reflectance. In another example, a light reflective element may be shared among a cluster of light emissive elements. The per-pixel emissive and/or reflective control signals may be sub-sampled or super-sampled for the purpose of generating per-element signals to control individual light emitting elements and/or light reflective elements.

In an example embodiment as illustrated in FIG. 4A, each pixel may comprise one light emitting element. Thus, the per-pixel signals intended for emissive component of the display panel (102) may be directly used to control the emissive display component (e.g., LEDs). In the example embodiment, each pixel may comprise more than one light reflective element. Thus, the per-pixel signals intended for the reflective component of the display panel (102) may be super-sampled to generate per-element control signals, which in turn may be used to control the reflective display component (e.g., e-paper). A distribution function may be used in sub-sampling or super-sampling to compute per-element signal values in the per-element control signals. Examples of distribution functions may include, without limitation, constant distributions, Gaussian distributions, Poisson distributions, etc. In an example, in sub-sampling, the distribution function may give more weighting to salient (e.g., central) pixels of an image portion than other pixels in the same image portion. In another example, in super-sampling, light reflective elements situated nearest to a pixel may be given reflectance levels more closely matching the luminance value of the pixel than other light reflective elements situated further away from the pixel. A variety of sub-sampling and/or super-sampling methods in determining per-element light output levels and/or light reflectance levels may be used in various embodiments.

In some embodiments, the input video signal may be separated into, or may be used to generate, a signal part comprising emissive control signals for all, or substantially all, the light emissive elements of the display panel (102) and another signal part comprising reflective control signals for all, or substantially all, the light reflective elements of the display panel (102).

In some other embodiments, a display panel may be divided into multiple segments. The input video signal may be separated into, or may be used to generate, multiple signal parts. Each signal part comprises emissive control signals for light emissive elements of each of the multiple segments of the display panel (102) and reflective control signals for light reflective elements of each of the multiple segments of the display panel (102).

FIG. 4B illustrates a flow chart representing some operations performed in a combined emissive and reflective dual modulation display system, in accordance with an embodiment. The combined emissive and reflective control module 304 of FIG. 3A and FIG. 3B may be configured to perform the operations depicted in FIG. 4A. The control module 304 may be configured to receive an input video stream from an image data source such as 306 of FIG. 3A. The control module 304 may comprise a video decoding processor configured to decode and separate video streams into a number of (e.g., n) portions of image frames. Each of the n portions of the image frames may be provided to sub-control modules (e.g., Segment 1, Segment 2, . . . , Segment n) for the n portions of the image frames.

A sub-control module (e.g., Segment 1) may be configured to determine a distribution of luminance values and color values of a (local) portion or segment of the display panel (102) based on pixel values in a corresponding portion of an image frame and/or neighboring portions of the image frame. Individual pixels (e.g., 104-1, 104-2, etc., of FIG. 1A) in the portion of the display panel (102) may be determined as expressing particular grayscale values or particular color values with particular luminance values.

The sub-control module (Segment 1) may be configured to generate a set of emissive control signals for a set of emissive light sources (or light emitting elements) in the local portion of the display panel (102) based on the image content of the local portion and/or neighboring portions of the image frame. The sub-control module (Segment 1) may be configured to use the set of emissive control signals to control emissive display components (e.g., one or more LED clusters) in the local portion or segment of the display panel (102).

The sub-control module (Segment 1) may be configured to generate local modulation of reflective components (or light reflective elements) in the local portion of the display panel (102) based on the image content of the local portion and/or neighboring portions of the image frame. In some embodiments, the local modulation of the reflective components may be a function of local emissive components. The sub-control module (Segment 1) may be configured to use the set of reflective control signals to reflective display components (e.g., one or more e-paper modules) in the local portion or segment of the display panel (102).

Additional energy consumption spent in controlling light reflective elements may be minimal as compared with energy consumption of the light emitting elements (e.g. LEDs). Image processing necessary to drive multi-layer light modulation of the light emitting elements and the light reflective elements may be performed on-board, off-board with remote processing logic, on segment with logic embedded with a portion of the display panel comprising one or more tiles, etc. Image processing may be performed jointly or separately for the multiple light modulation layers (e.g., 106 of FIGS. 1B and 108 of FIG. 1C). Additionally, optionally, or alternatively, image processing necessary to drive multi-layer light modulation may be performed locally within each segment of an image frame. In some embodiments, to simplify processing, the reflectivity of the background area in a segment may be determined as a function of the local light output levels of the light emitting elements in that segment and/or neighboring segments in the image frame.

### 6. Emissive Modules and Reflective Tiles

The manufacturing of large to huge reflective background areas or panels (e.g., for display systems used in a stadium) may be expensive. The mounting of light emitting elements through a reflective background may also be cumbersome. In some embodiments, to increase the production yield and to ease the installation task, the light emitting elements, or light reflective elements, or both the light emitting elements and the light reflective elements, may be modularized. For example, small reflective tiles may be used to surround one or more light emitting elements which may or may not be modularized in a portion of an overall display panel.

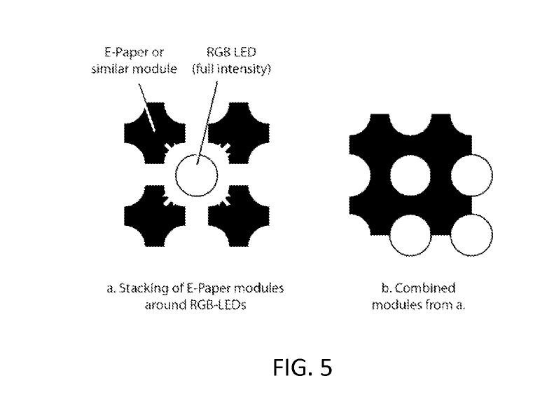

FIG. 5 illustrates an example tiling configuration in which emissive modules each of which comprises one or more light emitting elements may be interleaved with reflective tiles each of which comprises one or more light reflective elements. This configuration may be used to avoid drilling holes into the backplane of the reflective material. Additionally, optionally, or alternatively, the failure of a light emitting element and/or a reflective tile may be detected by turning on light emitting elements in a module or the whole display panel in a test mode. An image formed in the test mode may be analyzed e.g. by using an image capture system such as a digital camera to determine if any reflective tiles or any light emitting elements therein fail. If that is the case, the light emitting elements (or emissive modules) and/or the reflective tiles with failed components may be replaced, for example, individually.

In some embodiments, a single reflective tile may be used for multiple pixels. One or more light reflective elements in the single reflective tile may be individually controlled based on image data and/or an ambient light level; different parts of the single reflective tile may be of different albedos or reflectance levels at a given time. Additionally, optionally, or alternatively, the light reflective elements in the single reflective tile may be globally controlled based on image data and/or an ambient light level; different parts of the single reflective tile may be of the same albedo or reflectance level at a given time.

As described herein, an emissive module or a reflective tile, or a mixture of both, may be of any geometric shape including but not limited to any of: rectangular shapes, polygonal shapes, curved shapes, spherical shapes, concave shapes, convex shapes, irregular shapes, disjoint shapes, etc. The global shape of a rendering surface of a display panel may be formed collectively by emissive modules and/or reflective tiles of one or more individually different shapes. Spatial gaps may be configured between neighboring modules and/or tiles, for example, to allow thermal expanding or shrinking. A rendering surface, or a module or tile therein, may be a hard surface or a soft surface. Heat conductors may be used to dissipate heat in the display panel, which may be generated from on-board electronics, ambient light, projected light or light actively emitted from the display panel.

### 7. Passive Reflector

In some embodiments, light reflective elements may be configured with one or more photochromic materials (e.g., silver chloride, zinc halides, spiropyrans, spirooxazines, diarylethenes, azobenzenes, quinones, and others) that change reflectance as a function of incident light hitting the photochromic materials. For example, light emitting elements may be surrounded by the photochromic materials that provide a reflective background (e.g., coated or deposited on a surface of a display panel). The reflectance of the reflective background may vary as a function of incident light wavelengths. Additionally, optionally, or alternatively, the reflectance of the reflective background may reflect uniformly across a range of light wavelengths (e.g., the entire visible light wavelength range, substantially the entire visible light wavelength range, etc.). A photochromic material as described herein may be selected to be of the same polarity as a light emitting element. For example, the photochromic material may be selected to operate with a reflectance monotonically increasing (e.g., linearly proportional, non-linearly proportional, etc.) with the increase of incident light from the light emitting element. Additionally, optionally, or alternatively, the photochromic material may be selected to operate with a temporal response that supports a variety of display applications, for example, with various frame rates.

In an embodiment, a selected photochromic material as described herein may be configured to operate in relation to the illumination impinging the photochromic material. For example, if a local region of an image is dark, then an inter-pixel reflective region with the photochromic material in the local region goes into a low reflective state. On the other hand, if the local region is bright, then the inter-pixel reflective region goes into a high reflective state. The use of such a photochromic material leads to higher contrast, lower pixel grid visibility, and higher efficiency.

8. External Light Sources and/or Additional Modulation Layers

A display panel as described herein may be easily set up or erected in a stadium, concert, a cinema, a theater, a park, a side of a building, a billboard, an outdoor or indoor location, etc. In some embodiments, a display panel as described herein may be adapted to be used as one or more parts (which are not necessarily a contiguous flat panel of a regular shape but may also be disjointed parts that may or may not be optically connected with light guides or other optical links, or show anisotropic or retroreflective behavior) of a stage set in a theater, an exhibition space, an advertisement, etc. Additionally, optionally, or alternatively, zero, one or more external light sources may be used in conjunction with or in place of one or more light emitting elements as described herein to cause light reflection from light reflective elements as described herein. Examples of external light sources include, without limitation, lasers, LEDs, CCFLs, OLEDs, quantum dots, front projected light, side projected light, backlight, etc.

In some embodiments, a backlight unit may be provided by light emitting elements and light reflective elements as described herein. One or more light valve layers may be illuminated with light from the light emitting elements and the light reflective elements. An aggregate point-spread function may be implemented with a plurality of point-spread functions of the light emitting elements as modified by the light reflective elements. A display system as described herein may be configured to perform dual modulation, triple modulation, or even more layer modulation of active light sources, controllable light reflection area, light valve layers, etc.

Defective elements, whether light emitting elements or light reflective elements, may be detected by scanning a display panel with external light, by turning on light emitting elements, by executing test patterns for the light emitting elements or light reflective elements, by analyzing test images, etc. The defective elements may be replaced. A display system as described herein may also be configured with compensation logic for failed elements. If a light emitting element becomes defective (e.g., not emitting light, only emitting weak light, emitting partial light, etc.) in a display panel or a tile thereof, external light sources, light reflective elements collocated with the light emitting element, nearby light emitting elements or light reflective elements may be configured to compensate for the failure of the light emitting element. For example, light reflective elements may increase light reflectance levels more than normal in order to compensate for the defective light emitting element. The reflective area around a failed light emitting element may be overdriven to alleviate the lack of light coming from the failed light emitting element by scattering light form adjacent working light emitting elements. Additionally, optionally, or alternatively, a laser beam or a light guide may be used within a display device to steer additional light to the affected pixel. Additionally, optionally, or alternatively, nearby pixels may divert light to the defective pixel.

### 9. Modulation Algorithms

A display system as described herein may be configured to drive light emitting elements and light reflective elements based on image data. Local drive values of the light emitting elements and the light reflective elements may be obtained based on local analysis of corresponding pixels in the image data. Both light emission from the light emitting elements and light reflection from the light reflective elements may be modulated based on the image data. The modulated light reflection includes, without limitation, back scattering light and/or light directed to certain directions, for example through light guiding components. The light emission and/or light reflectance may also be adjusted based on an ambient light level.

One or more modulation algorithms may be implemented by a display system (e.g., display controller 302 of FIG. 3) to drive light emitting elements and light reflective elements based on image data and/or an ambient light level. In an example, a single modulation algorithm may be used to control both the light emitting elements and light reflective elements. In another example, two or more modulation algorithms may be used to control separately the light emitting elements and the light reflective elements. The modulation algorithms may communicate with one another and share one or more system resources, data, and analysis results, etc. For example, control values generated for one or more light emitting elements in an image or a location portion thereof may be provided as feedback to algorithms generating control values for one or more light reflective elements in the image or the same or a different location portion thereof. Likewise, control values generated for one or more light reflective elements in an image or a location portion thereof may be provided as feedback to algorithms generating control values for one or more light emitting elements in the image or the same or a different location portion thereof.

To control a pixel's luminance value, color value, and/or spatial size (e.g., point-spread function), one or more modulation algorithms may be configured to set light output levels of one or more light emitting elements in the pixel and/or neighboring pixels adjacent to the pixel and one or more light reflective elements in the pixel and/or the neighboring pixels.

One or more modulation algorithms may be configured to generate images with high energy savings. In a pixel comprising a light emitting element and a light reflective element, to express a luminance value of 200 units, instead of setting the light output level of the light emitting element to 200 units with a non-reflective background, the modulation algorithms may set the light output level of the light emitting element to 180 and set a specific reflectance level of the light reflective element that results in additional reflected light equaling to 20 units savings for energy consumption. In some embodiments, the light reflective element may be overdriven to large values or even the maximum light reflection value, and the light emitting element may be normally or under-driven so long as the total light output from the pixel and the total spatial size (or point-spread function) provide accurate rendering based on corresponding pixel values in the received image data. Thus, a display system as described herein may be configured to operate in a way that reduces energy consumption and heat dissipation while maintaining high image quality.

Additionally, optionally, or alternatively, one or more modulation algorithms may be configured to adjust a point-spread function or spatial size of a pixel. If the pixel is surrounded by pixels of like pixel values, the modulation algorithms may be configured to increase the spatial size of the pixel to remove or reduce the black matrix artifact and/or to create a point-spread function with relatively uniform light distribution. If the pixel is adjacent to pixels of different pixel values (e.g., different colors, bright versus dark, etc.), the modulation algorithms may be configured to decrease the spatial size of the pixel and/or to create a point-spread function with relatively steeply varied light distribution, in order to increase contrast between image portions with different pixel values. Other variations in setting spatial sizes and/or point-spread functions may be implemented by modulation algorithms as described herein.

Additionally, optionally, or alternatively, one or more modulation algorithms may be configured to generate images with high dynamic range using both light emitting elements and light reflective elements. To create a dark black state of a pixel in the current example, both the light emitting element and the light reflective element may be set to dark states. This dark black state may be comparable to or at least as good as a dark black state in a display system that does not implement modulation techniques as described herein. To create a bright state of a pixel in the current example, both the light emitting element and the light reflective element may be set to high light output level and high reflectance level. This bright state may be significantly brighter than a bright state in a display system that does not implement modulation techniques as described herein. As a result, a display system as described herein may be used to generate a higher dynamic range image than that rendered by a display system that does not implement modulation techniques as described herein. Images rendered by the display system may support viewing at a greater distance than otherwise.

Additionally, optionally, or alternatively, one or more modulation algorithms may be configured to generate images with highly saturated colors using both light emitting elements and light reflective elements. To create a saturated color for a pixel in the current example, both the light emitting element and the light reflective element may be set to high light output level and high reflectance level for specific light wavelengths or specific colors. The saturated color may comprise a significantly higher luminance and purity in color than a color generated by a light emitting element alone in a display system that does not implement modulation techniques as described herein. As a result, a display system as described herein may be used to generate wider color gamut images than those rendered by a display system that does not implement modulation techniques as described herein.

A display system as described herein may be configured with one or more modulation algorithms to operate in one or more operating modes each of which may correspond to controlling light emitting elements and light reflective elements with a priority placed on one or more of energy consumption, pixel spatial size, dynamic range, color gamut, light emitting elements, light reflective elements, mutual/cooperative modulations of light emitting elements and light reflective elements, etc.

In some embodiments, maximal spatial resolutions supportable by light reflective elements and light emitting elements may be the same. In some embodiments the maximal spatial resolutions may be different. Sub-sampling and/or super-sampling may be performed when spatial resolutions are different. Examples of different spatial resolutions between light emitting elements and light reflective elements include, without limitation, a display panel in which a pixel may comprise a single light emitting element but a plurality of light reflective elements (e.g., e-paper based reflective background) that may be controlled individually or as a whole. A display system as described herein may be configured with one or more modulation algorithms to perform sub-sampling and/or super-sampling. The modulation algorithms may set reflectance levels or light output values uniformly. The modulation algorithms may set light grading from a relatively dark state to a relatively bright state by setting different reflectance levels of the light reflective elements in a pixel, a tile, or an image, and/or by setting different light output values of the light emitting elements in a pixel, a tile, or an image. In some embodiments, light reflectance levels of one or more light reflective elements adjacent to a light emitting element may be set to such values that reflected light from the reflective elements matches (e.g., in light intensity) light directly emitted from the light emitting element to a viewer. Specific point-spread functions may be generated or shaped by coarsely or finely controlling the light emitting elements and/or the light reflective elements individually, as a portion, or as a whole.

### 10. Example Process Flow

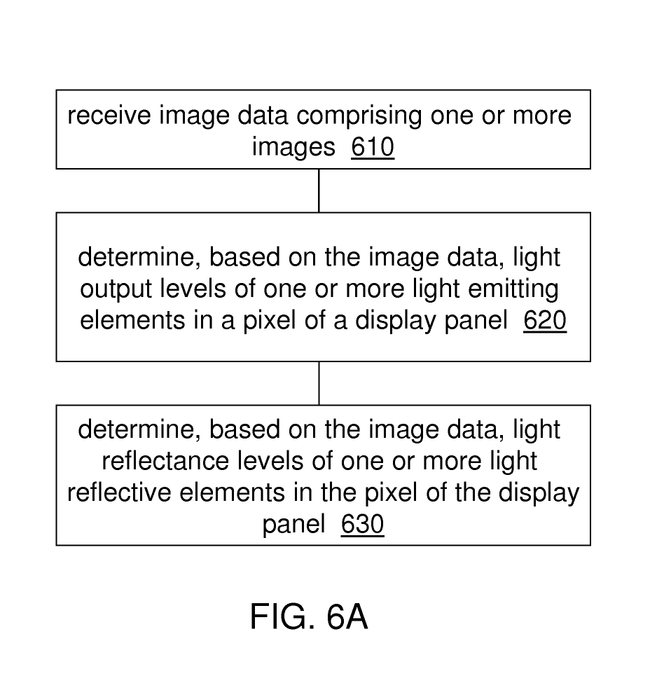

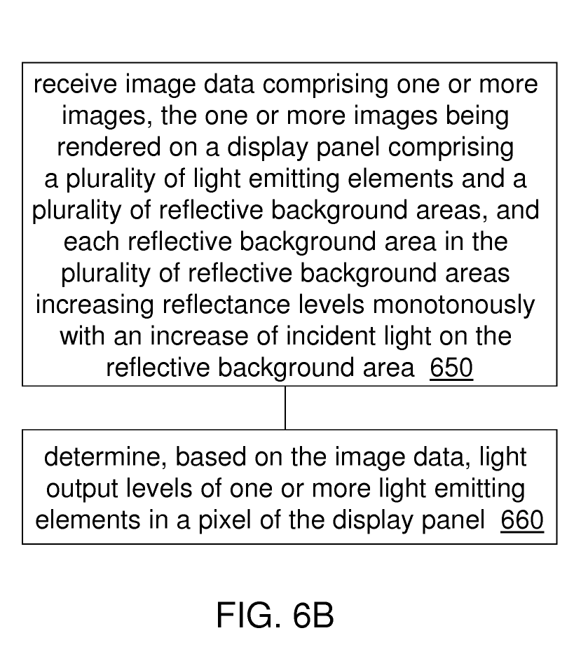

FIG. 6A illustrates an example process flow according to an embodiment of the present invention. In some embodiments, one or more computing devices or components in a display system comprising display controller 302 and combined emissive and reflective control module 304 may perform this process flow. In block 610, the display system receives image data to display one or more images.

In block 620, the display system determines, based on the image data, light output levels of one or more light emitting elements in a pixel of a display panel.

In block 630, the display system determining, based on the image data, light reflectance levels of one or more light reflective elements in the pixel of the display panel, the light output levels of the light emitting elements and the light reflectance levels of the light reflective elements being configured to generate collectively a pixel value for the pixel and wherein the pixel value for the pixel is specified in the image data for at least one of the one or more images.

In an embodiment, the one or more light reflective elements in the pixel comprises at least one based on: quantum dots, photochromic materials, e-paper, e-ink, reflective liquid crystal display, etc.

In an embodiment, one or more modulation algorithms are used to determine at least one of the light output levels of the one or more light emitting elements in the pixel or the light reflectance levels of the one or more light reflective elements in the pixel. In an embodiment, the one or more modulation algorithms are implemented in one or more of: remote processing logic, local processing logic with a display panel, local processing logic with one or more segments of a display panel, etc.

In an embodiment, the light reflectance levels of the one or more light reflective elements in the pixel comprise at least an overdriven value configured to reduce energy consumption of display operations.

In an embodiment, the light output levels of the one or more light emitting elements in the pixel or the light reflectance levels of the one or more light reflective elements in the pixel comprise values configured to increase dynamic range relating to rendered images.

In an embodiment, the light output levels of the one or more light emitting elements in the pixel or the light reflectance levels of the one or more light reflective elements in the pixel comprise values configured to increase color gamut relating to rendered images.

In an embodiment, the light output levels of the one or more light emitting elements in the pixel or the light reflectance levels of the one or more light reflective elements in the pixel comprise values configured to generate a specific point-spread function for the pixel. In an embodiment, the specific point-spread function for the pixel increases a spatial size of the pixel as perceived by a viewer of the display panel. In an embodiment, the specific point-spread function for the pixel is configured with a smooth transition in light intensity between first viewable area portions formed by the one or more light emitting elements and second viewable area portions formed by the one or more light reflective elements. In an embodiment, the specific point-spread function for the pixel decreases a spatial size of the pixel as perceived by a viewer of the display panel.

In an embodiment, the light reflectance levels of the one or more light reflective elements in the pixel comprise at least two different values.

FIG. 6B illustrates an example process flow according to an embodiment of the present invention. In some embodiments, one or more computing devices or components in a display system comprising display controller 302 and combined emissive and reflective control module 304 may perform this process flow. In block 650, the display system receives image data comprising one or more images, the one or more images being rendered on a display panel comprising a plurality of light emitting elements and a plurality of reflective background areas, and each reflective background area in the plurality of reflective background areas increasing reflectance levels monotonously with an increase of incident light on the reflective background area.

In block 660, the display system determines, based on the image data, light output levels of one or more light emitting elements in a pixel of a display panel, the light output levels of the light emitting elements and the light reflectance levels of one or more reflective background areas in the pixel being configured to generate collectively a pixel value for the pixel and wherein the pixel value for the pixel is specified in the image data for at least one of the one or more images.

In an embodiment, the one or more light emitting elements in the pixel comprises at least one of: light-emitting diodes (LEDs), cold cathode fluorescent lights (CCFLs), quantum-dot based light sources, organic light-emitting diodes (OLEDs), fluorescent light sources, incandescent light sources, gas discharge lights, etc.

In an embodiment, at least one of the one or more reflective background areas in the pixel is reflective across a broad spectrum of wavelengths.

In an embodiment, at least one of the one or more reflective background areas in the pixel is reflective in one or more narrow spectral ranges of light wavelengths.

In an embodiment, the display system is further configured to irradiate at least one of the one or more reflective background areas in the pixel with one or more external light source other than light emitting elements in a plurality of pixels of the display panel.

In an embodiment, the display panel comprises one or more of: rectangular shapes, polygonal shapes, curved shapes, spherical shapes, concave shapes, convex shapes, irregular shapes, disjoint shapes, etc.

In an embodiment, the display panel is provided with a display panel of a wall display system in one of: a stadium, a concert hall, a cinema, a theater, a park, an advertisement, a side of a building, an outdoor location, an indoor location, etc.

In an embodiment, the display panel is formed by a plurality of modules, and wherein each module in the plurality of modules comprises one of: a light emissive module (e.g., an emissive module), a light reflective module (e.g., a reflective tile), a combined light emissive and reflective module (e.g., a reflective tile on which one or more light emitting elements are mounted), etc.

Embodiments include an apparatus comprising a processor and configured to perform any one of the foregoing methods.

Embodiments include a computer readable storage medium, storing software instructions, which when executed by one or more processors cause performance of any one of the foregoing methods.

### 11. Implementation Mechanisms—Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

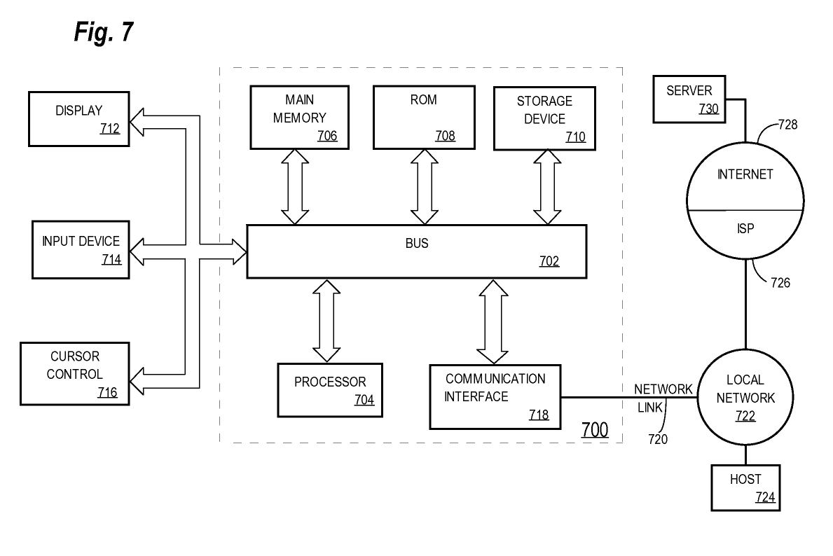

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a liquid crystal display (LCD), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718. The received code may be executed by processor 704 as it is received, and/or stored in storage device 710, or other non-volatile storage for later execution.

### 12. Equivalents, Extensions, Alternatives and Miscellaneous

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method comprising:
receiving image data comprising one or more images;
determining, based on the image data, light output levels of one or more light emitting elements in a pixel of a display panel; and
determining, based on the image data, light reflectance levels of one or more light reflective elements in the pixel of the display panel, the light output levels of the light emitting elements and the light reflectance levels of the light reflective elements being configured to generate collectively a pixel value for the pixel.

2. The method of claim 1, wherein the one or more light emitting elements in the pixel comprises at least one of: light-emitting diodes (LEDs), cold cathode fluorescent lights (CCFLs), quantum-dot based light sources, organic light-emitting diodes (OLEDs), fluorescent or phosphorescent light sources, incandescent light sources, gas discharge lights, or chemi- or bioluminescent lights.

3. The method of claim 1, wherein the one or more light reflective elements in the pixel comprises at least one based on: quantum dots, photochromic materials, e-paper, e-ink, or reflective liquid crystal display.

4. The method of claim 1, wherein one or more modulation algorithms are used to determine at least one of: the light output levels of the one or more light emitting elements in the pixel or the light reflectance levels of the one or more light reflective elements in the pixel.

5. The method of claim 4, wherein the one or more modulation algorithms are implemented in one or more of: remote processing logic, local processing logic with a display panel, or local processing logic with one or more segments of a display panel.

6. The method of claim 1, wherein the light reflectance levels of the one or more light reflective elements in the pixel comprise at least an overdriven value configured to reduce energy consumption of display operations.

7. The method of claim 1, wherein the light output levels of the one or more light emitting elements in the pixel or the light reflectance levels of the one or more light reflective elements in the pixel comprise values configured to increase dynamic range relating to rendered images.

8. The method of claim 1, wherein the light output levels of the one or more light emitting elements in the pixel or the light reflectance levels of the one or more light reflective elements in the pixel comprise values configured to increase color gamut relating to rendered images.

9. The method of claim 1, wherein the light output levels of the one or more light emitting elements in the pixel or the light reflectance levels of the one or more light reflective elements in the pixel comprise values configured to generate a specific point-spread function for the pixel.

10. The method of claim 9, wherein the specific point-spread function for the pixel increases a spatial size of the pixel as perceived by a viewer of the display panel.

11. The method of claim 9, wherein the specific point-spread function for the pixel is configured with a smooth transition in light intensity between first viewable area portions formed by the one or more light emitting elements and second viewable area portions formed by the one or more light reflective elements.

12. The method of claim 9, wherein the specific point-spread function for the pixel decreases a spatial size of the pixel as perceived by a viewer of the display panel.

13. The method of claim 1, wherein the light reflectance levels of the one or more light reflective elements in the pixel comprise at least two different values.

14. The method of claim 1, further comprising adjusting at least one of the light output levels or light reflectance levels based on an ambient light level.

15. The method of claim 1, wherein at least one of the one or more light reflective elements in the pixel is configured to reflect light in one or more spectral power distributions of light wavelengths, and wherein the light wavelengths in the one or more spectral power distribution comprise one or more of a panchromatic wavelength range, visible light wavelengths, ultraviolet light wavelengths, or infrared light wavelengths.

16. The method of claim 1, further comprising irradiating at least one of the one or more light reflective elements in the pixel with one or more external light source other than light emitting elements in a plurality of pixels of the display panel.

17. The method of claim 1, wherein the display panel comprises one or more of: curved shapes, spherical shapes, concave shapes, convex shapes, irregular shapes, or disjoint shapes.

18. The method of claim 1, wherein the display panel is provided with a display panel of a wall display system in one of: a stadium, a concert hall, a cinema, a theater, a park, an advertisement, or a side of a building.

19. The method of claim 1, wherein the display panel is formed by a plurality of modules, and wherein each module in the plurality of modules comprises one of: a light emissive module, a light reflective tile, or a light reflective tile on which at least one light emitting element is mounted.

20. A method comprising:
receiving image data comprising one or more images, the one or more images being rendered on a display panel comprising a plurality of light emitting elements and a plurality of reflective background areas, and each reflective background area in the plurality of reflective background areas increasing reflectance levels monotonously with an increase of incident light on the reflective background area; and
determining, based on the image data, light output levels of one or more light emitting elements in a pixel of the display panel, the light output levels of the light emitting elements and the light reflectance levels of one or more reflective background areas in the pixel being configured to generate collectively a pixel value for the pixel.

21. The method of claim 20, wherein the one or more light emitting elements in the pixel comprises at least one of: light-emitting diodes (LEDs), cold cathode fluorescent lights (CCFLs), quantum-dot based light sources, organic light-emitting diodes (OLEDs), fluorescent and phosphorescent light sources, incandescent light sources, gas discharge lights, or chemi- or bioluminescent light sources.

22. The method of claim 20, wherein further comprising adjusting at least one of the light output levels or light reflectance levels based on an ambient light level.

23. The method of claim 20, wherein at least one of the one or more light reflective elements in the pixel is configured to reflect light in one or more spectral power distributions of light wavelengths, and wherein the light wavelengths in the one or more spectral power distribution comprise one or more of a panchromatic wavelength range, visible light wavelengths, ultraviolet light wavelengths, or infrared light wavelengths.

24. The method of claim 20, further comprising irradiating at least one of the one or more reflective background areas in the pixel with one or more external light source other than light emitting elements in a plurality of pixels of the display panel.

25. The method of claim 20, wherein the display panel comprises one or more of: curved shapes, spherical shapes, concave shapes, convex shapes, irregular shapes, or disjoint shapes.

26. The method of claim 20, wherein the display panel is provided with a display panel of a wall display system in one of: a stadium, a concert hall, a cinema, a theater, a park, an advertisement, or a side of a building.

27. The method of claim 20, wherein the display panel is formed by a plurality of modules, and wherein each module in the plurality of modules comprises one of: a light emissive module, a light reflective tile, or a reflective tile on which at least one light emitting element is mounted.
